(19) United States
(12) Patent Application Publication
(10) Pub. No.: US 2010/0302612 A1
(43) Pub. Date: Dec. 2, 2010

(54) OSCILLATING STRUCTURE AND OSCILLATOR DEVICE USING THE SAME

(75) Inventors: Takashi Ushijima, Nagoya-shi (JP); Shinichiro Watanabe, Yamato-shi (JP); Suguru Miyagawa, Tokyo (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/745,628

(22) PCT Filed: Feb. 20, 2009
(86) PCT No.: PCT/JP2009/053625

§ 371 Date: Jun. 1, 2010

(30) Foreign Application Priority Data
Feb. 20, 2008 (JP) 2008-039002

(51) Int. Cl. G02B 26/08; F16H 21/44

(52) U.S. Cl. 359/213.1; 74/96

(57) ABSTRACT

An oscillating structure includes a supporting member, a first oscillating member, second oscillating member, a first resilient supporting member configured to connect the supporting member and the first oscillating member and to support the first oscillating member for oscillatory motion around the supporting member as a central axis, and a second resilient supporting member configured to connect the first oscillating member and the second oscillating member and to support the second oscillating member movably relative to the first oscillating member, wherein the direction in which the first resilient supporting member extends from the supporting member to the first oscillating member and the direction in which the second resilient supporting member extends from the first oscillating member to the second oscillating member are opposite to each other.

### TECHNICAL FIELD

This invention relates to an oscillating structure having a plurality of oscillating members and a plurality of resilient supporting members, an oscillator device using an oscillating structure, an optical deflecting device using an oscillator device, and an image forming apparatus using an optical deflecting device, for example. This optical deflecting device can be preferably used in an image forming apparatus such as a scanning display unit, a laser beam printer or a digital copying machine, for example.

### BACKGROUND ART

Conventionally, many types of optical deflecting devices in which a mirror is driven by resonance have been proposed. As compared with optical scanning optical systems using a rotary polygonal mirror such as a polygon mirror, the resonance type optical deflecting devices have advantageous features such as: the optical deflecting device can made quite small in size; the power consumption is slow; there is theoretically no surface tilt of the mirror surface; and particularly the optical deflecting device made of Si monocrystal manufactured by semiconductor processes have theoretically no metal fatigue and have good durability (see U.S. Pat. No. 4,317,611).

On the other hand, in the electrophotography such as a laser beam printer, an image is formed by scanning a photosensitive member surface with a laser beam. The scan speed during the scan should desirably be made constant on the photosensitive member surface. In consideration of this, generally, in optical scanning means to be used in the electrophotography, after scanning the light beam by an optical deflecting device, optical correction is carried out.

For example, in an optical-scanning optical system using a rotary polygonal mirror, an imaging lens called an fθ lens is used so as to convert a light beam reflectively deflected by a deflective reflection surface of the rotary polygonal mirror at a constant angular speed into a constant-speed scan beam upon the photosensitive member.

As compared therewith, in resonance type deflection devices, since the displacement angle of the mirror changes theoretically sinusoidally, the angular speed is not constant. Some techniques have been proposed to correct this characteristic. According to a proposal of optical correction, an imaging lens called an arcsine lens is used to convert a light beam from a mirror having an angular speed changing sinusoidally into a constant-speed scan beam on a photosensitive member. According to a proposal not based on optical correction, a resonance type deflection device having oscillation modes of a fundamental frequency and a frequency three-fold of the fundamental frequency is used to accomplish approximately chopping wave driving (see U.S. Pat. No. 4,859,846). According to another proposal not based on optical correction, a system comprising a nest type oscillating structure having a plurality of resilient supporting members and a plurality of oscillating members is used to accomplish approximately constant angular-speed driving (see International Publication No. WO2005/063613).

### DISCLOSURE OF THE INVENTION

However, in the aforementioned resonance type deflection device which provides approximately chopping wave driving or approximately constant angular-speed driving, since the oscillating members and resilient supporting members are disposed in series, it is very difficult to reduce the size of the deflection device.

The present invention provides an oscillating structure and/or an oscillator device having the same by which the aforementioned inconveniences can be removed or reduced.

Specifically, in accordance with an aspect of the present invention, there is provided an oscillating structure, comprising: a supporting member; a first oscillating member; a second oscillating member; a first resilient supporting member configured to connect the supporting member and the first oscillating member and to support the first oscillating member for oscillatory motion around the supporting member as a central axis; and a second resilient supporting member configured to connect the first oscillating member and the second oscillating member and to support the second oscillating member movably relative to the first oscillating member; wherein the direction in which the first resilient supporting member extends from the supporting member to the first oscillating member and the direction in which the second resilient supporting member extends from the first oscillating member to the second oscillating member are opposite to each other.

The first and second oscillating members and the first and second resilient supporting member may be made of a single piece of plate-like member.

A portion of the first oscillating member and the first resilient supporting member, and the second oscillating member, the second resilient supporting member and a portion of the first oscillating member may be made from separate plate-like members, wherein the portions of the first oscillating member may be joined together.

At least one of the first resilient supporting member and the second resilient supporting member may comprise a plurality of torsion springs.

One of the first resilient supporting member and the second resilient supporting member which comprises a plurality of torsion springs may be configured to sandwich therein the other of the first resilient supporting member and the second resilient supporting member.

The first resilient supporting member and the second resilient supporting member may have a common torsion central axis.

In accordance with another aspect of the present invention, there is provided an oscillating structure, comprising: a supporting member; a plurality of oscillating members; and a plurality of resilient supporting members; wherein, in an order from the supporting member, the resilient supporting members and the oscillating members are alternately connected, and wherein the direction in which an “n”th resilient supporting member connected to an “n”th oscillating member extends, where n is an integer not less than 1 as counted from the supporting member side, and the direction in which an “n+1”th resilient supporting member connected to an “n+1”th oscillating member extends are opposite to each other.

In accordance with a further aspect of the present invention, there is provided an oscillator device, comprising: an oscillating structure as recited above; and driving means configured to apply a torque to at least one of the first and second oscillating members of the oscillating structure.

In accordance with a yet further aspect of the present invention, there is provided an optical deflecting device, comprising: an oscillator device as recited above; and an optical deflection member disposed at least at the second oscillating member of the oscillator device.

In accordance with a still further aspect of the present invention, there is provided an image forming apparatus, comprising: an optical deflecting device as recited above; a light source; an imaging optical system; and an object to be irradiated, wherein a light beam from the light source is scanned by the optical deflecting device and the scanned light is collected onto the object.

Briefly, in accordance with the present invention, since a plurality of resilient supporting members of the oscillating structure are turned around, the overall size of the device can be made small yet it has a plurality of oscillating members. For example, the number of products of oscillating structures obtainable from a single piece of wafer increases, and thus the cost of the oscillating structure decreases. Furthermore, an oscillator device using an oscillating structure of the present invention or an image forming apparatus such as a laser beam printer or a digital copying machine into which an optical deflecting device is incorporated can be made small in size.

Furthermore, since the oscillating structure of the present invention is comprised of a plurality of resilient supporting members and a plurality of oscillating members, it may have a plurality of oscillation modes. Therefore, in a resonance type oscillator device using the same, a plurality of oscillation modes can be synthesized flexibly to produce a drive, in accordance with the application wherein the oscillator device is used. For example, it can produce in the oscillating member a desired oscillation around a central axis in which fluctuation of the angular speed is well suppressed. Such a resonance type oscillator device can be preferably used in an image forming apparatus such as a laser beam printer or a digital copying machine.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1A and FIG. 1B are diagrams illustrating an oscillating structure and an oscillator device according to a first embodiment of the present invention.

FIG. 2A and FIG. 2B are diagrams illustrating a change with respect to time of the displacement angle of a sawtooth waveform and an approximately constant angular speed of an oscillating member according to the first embodiment of the present invention.

FIG. 3A and FIG. 3B are diagrams illustrating a change with respect to time of the displacement angle of a chopping waveform and an approximately constant angular speed of an oscillating member according to a second embodiment of the present invention.

FIG. 4A and FIG. 4B are diagrams illustrating an optical deflecting device according to an embodiment of the present invention.

FIG. 5 is a diagram illustrating an image forming apparatus according an embodiment of the present invention.

FIG. 6 is a plan view illustrating an oscillating structure according to a third embodiment of the present invention.

FIG. 7 is a plan view illustrating an oscillating structure according to a fourth embodiment of the present invention.

FIG. 8 is a perspective view illustrating an oscillating structure according to a fifth embodiment of the present invention.

FIG. 9A and FIG. 9B are plan views illustrating a method of manufacturing an oscillating structure, according to an embodiment of the present invention.

FIG. 10A and FIG. 10B are plan views illustrating a method of manufacturing an oscillating structure, according to another embodiment of the present invention.

FIG. 10C and FIG. 10D are plan views illustrating a method of manufacturing an oscillating structure, according to another embodiment of the present invention.

FIG. 11 is a plan view illustrating features of a method of manufacturing an oscillating structure in the present invention, in comparison with a comparative example.

### BEST MODE FOR PRACTICING THE INVENTION

Preferred embodiments of the present invention will now be described with reference to the attached drawings.

A basic structure of an oscillating structure according to the present invention may comprise a supporting member, a plurality of oscillating members and a plurality of resilient supporting members. A first resilient supporting member extending from the supporting member to the first oscillating member and a second resilient supporting member extending from the first oscillating member to the second oscillating member may extend in approximately opposite directions and may be folded back. Furthermore, if the basic structure further comprises a third oscillating member, a third resilient supporting member extending from the second oscillating member to the third oscillating member and the second resilient supporting member extending from the first oscillating member to the second oscillating member may extend in approximately opposite directions and may be folded back again. If there is a necessary of providing a fourth oscillating member or more, such a folding structure may be repeated.

Furthermore, in more general, a basic structure of an oscillating structure according to the present invention may comprise a supporting member, a plurality of oscillating members and a plurality of resilient supporting members, wherein, in an order from the supporting member, the resilient supporting members and the oscillating members may be connected alternately. Here, the direction in which an “n”th resilient supporting member connected to an “n”th oscillating member extends, where n is an integer not less than 1 as counted from the supporting member side, and the direction in which an “n+1”th resilient supporting member connected to an “n+1”th oscillating member extends may be opposite to each other. If three or more oscillating members and three or more resilient supporting members are included, a folding structure of a plurality of resilient supporting members as well as a structure of a plurality of resilient supporting members placed in series may be included. In such a structure, as a matter of course, spacings should be held between adjacent oscillating members and resilient supporting members so that they do not contact each other during the operation.

The “n”th resilient supporting member and the “n”th oscillating member, where n is an integer not less than 1, may be considered as a pair, and all such pairs may be provided in the same plane. Alternatively, some pair or pairs may be provided in a separate plane which is perpendicularly spaced apart from a plane defined by the first resilient supporting member and the first oscillating member. If all the pairs of the resilient supporting members and the oscillating members are provided in the same plane, the spacings between them should be formed in the same plane. If there is a pair or pairs at a plane perpendicularly space apart, the spacings between the resilient supporting members and the oscillating members may be provided by the distance between the separate planes or by the spacings along the same plane. Alternatively, the spacings may be provided by both of them.

Furthermore, the oscillating member may be supported for oscillatory motion (torsional oscillation) around the resilient supporting member. Namely, the resilient supporting member may function as a torsion spring.

With the folding structure of a plurality of resilient supporting members such as described above, the size of the whole oscillating structure can be made small while a plurality of oscillating members are included.

### Embodiment 1

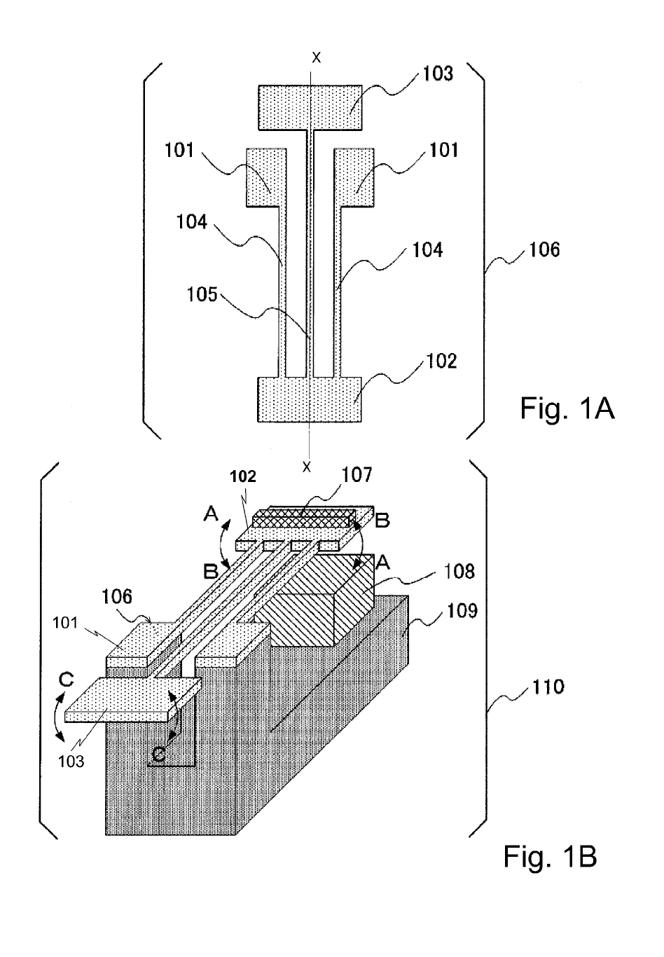

Referring to FIG. 1A through FIG. 5, s first embodiment of an oscillating structure, an oscillator device, an optical deflecting device and an image forming apparatus according to the present invention will be described. First of all, using FIG. 1A through FIG. 3B, the structural features and the principle of operation of the oscillating structure and the oscillator device of the present embodiment will be explained.

FIG. 1A is a plan view showing an oscillating structure such as a small micro-oscillating structure, according to the present embodiment. This oscillating structure 106 comprises a pair of supporting members 101, a first oscillating member 102, a second oscillating member 103, a first torsion spring 104 which is comprised of a pair of springs (first resilient supporting members), and a second torsion spring 105 (second resilient supporting member). Each spring of the first torsion spring 104 extends from a corresponding supporting member 101 to the first oscillating member 102, to support the first oscillating member 102 movably relative to the supporting member 101. The second torsion spring 105 which is a single piece of element extends from the first oscillating member 102 to the second oscillating member 103, to support the second oscillating member 103 movably relative to the first oscillating member 102.

In this configuration, the first torsion spring 104 is configured so that, based on flexure of two spring elements, the oscillating structure produces torsional driving. Here, the first torsion spring 104 and the second torsion spring 105 have a common axis X which is the center of torsional motion. To this end, various components of the device should preferably have a laterally symmetrical shape for stable operation. However, as a matter of course, depending on the application, the components may be formed to have a laterally asymmetrical shape.

FIG. 1B is a perspective diagram showing an oscillator device 110 of the present embodiment using an oscillating structure 106 mentioned above. The oscillator device is comprised of an oscillating structure 106 of FIG. 1A having a rod-like permanent magnet 107 mounted thereon, the oscillating structure 106 being is attached to a support member 109 having an electromagnetic coil 108 mounted thereon. The permanent magnet 107 and the electromagnetic coil 108 constitute driving means for applying a torque to at least one of the first and second oscillating members. A pair of supporting members 101 of the oscillating structure 106 are attached to a pair of protrusions of the supporting member 109, respectively. The electromagnetic coil 108 on a planar member of the supporting member 109 is disposed near the permanent magnet 107 on the first oscillating member 102 of the oscillating structure 106.

When an electric current is applied to the electromagnetic coil 108 of the oscillator device 110 having the structure described above from drive control means for controlling the driving means, a repulsive force and an attraction force are produced between it and the permanent magnet 107. The magnetic poles of the permanent magnet 107 are so arranged to produce such repulsive force and attraction force, and the electric wiring of the electromagnetic coil 108 is set accordingly. By this repulsive force and attraction force, a torque around the axis X acts on the oscillating structure 106, and thus the oscillating member is oscillated. More specifically, a force couple is given to the permanent magnet 107 and it causes the oscillating structure 106 to produce oscillatory motion around the axis X. In this case, if the frequency of the spacing of the electric current to be applied to the electromagnetic coil 108 is made approximately equal to the natural oscillation frequency of the natural oscillation mode of the oscillating structure 106 or to an n-fold of the same (n is an integer), the torsion angle (oscillation amplitude) of the oscillating structure 106 can be increased.

In other words, the oscillating structure 106 of the present embodiment has a plurality of discrete natural oscillation modes. Then, in the discrete natural oscillation modes, a reference oscillation mode which is a natural oscillation mode of a reference frequency and an integral-multiple oscillation mode which is a natural oscillation mode of a frequency approximately n-fold the reference frequency (n is an integer) are included. Here, if the resonance frequency of the reference oscillation mode is denoted by f₁ and the resonance frequency of the integral-multiple oscillation mode is denoted by f₂ and where N is an integer not less than 2, there is a relationship:

0.98 N≦f2/f1≦1.02 N

Generally, the structure has various natural oscillation modes. With regard to the oscillating structure 106 of the present embodiment, it has a mode in which the first torsion spring 104 and the second torsion spring 105 are twisted in the same direction around the axis X, and a mode in which they are twisted in an opposite direction. Explaining this using FIG. 1B, the oscillating structure 106 operates to produce torsional oscillation so that the torsional oscillations of the first oscillating member 102 and the second oscillating member 103 match a combination of A-C (combination of oscillations in the same direction) or, alternatively, a combination of B-C (combination of oscillations in opposite directions). Hereinafter, the combination of A-C will be referred to as a translational mode, while the combination of B-C will be referred to as a regress mode.

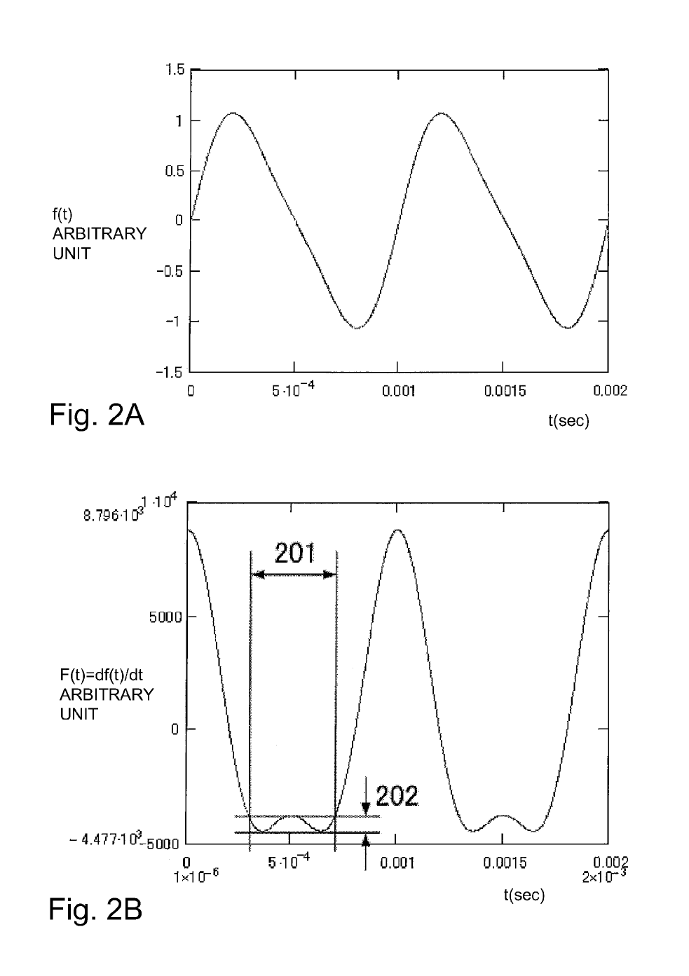

If the driving is performed based on the combination the translational mode and regress mode, a change with respect to time of the displacement angle of the oscillating member in the sawtooth waveform can be obtained. This is explained in Patent Document No. 1 mentioned hereinbefore. The shape of the device or the like can be designed so that the translational mode is produced at sin(ω·t) and the regress mode is produced at sin(2·ω·t) and, while multiplying them by respective predetermined coefficients, these are added to each other (equation 1). Here, assuming that ω=2·π·f, then it becomes possible to cause the second oscillating member 103 to produce torsional oscillation having a change with respect to time of the displacement angle of the sawtooth waveform as shown in FIG. 2A. Here, f=1000 [Hz] is used.

f(t)=sin(ω·t)+0.2·sin(2·ω·t) (1)

If equation (1) is differentiated, the angular speed F(t) shown in FIG. 2B can be obtained. Thus, an approximately constant angular speed time 201 as well as an approximately constant angular speed range (speed variation tolerance range) 202 can be determined. Here, the approximately constant angular speed range and the approximately constant angular speed time can be changed depending on the application or the design. For example, these can be changed by changing the value of 0.2 in equation (1). In the driving based on this sawtooth waveform, the time in which the displacement angle of the second oscillating member 103 increases and the time in which the increased displacement angle decreases are different.

When an optical deflecting device using an oscillator device 110 of the present embodiment is incorporated into an image forming apparatus, depending on the design of an imaging optical system disposed between a photosensitive member and the optical deflecting device to be described below, the approximately constant angular speed range and the approximately constant angular speed time can be determined. By using the sawtooth waveform as mentioned above, the approximately constant angular speed range can be used promptly and repeatedly. This waveform is particularly suitable when a photosensitive member should be scanned by a laser beam, by one direction scan.

Since the oscillating structure 106 of the present embodiment shown in FIG. 1A has such shape that the first torsion spring 104 and the second torsion spring 105 extend in parallel to each other and then these are folded, the size thereof can be made particularly small. As a result, the manufacturing cost can be reduced, and the size of an image forming device having such optical deflecting device can be reduced as well.

In the oscillating structure 106 of the present embodiment shown in FIG. 1A, the first torsion spring 104 comprises a plurality of springs, and the second torsion spring 105 is sandwiched by the first torsion spring 104. With this arrangement, the torsion central axes of these springs can be easily aligned with each other. With this structure, unwanted shift of the torsion center during the operation can be avoided, and stable oscillation of the oscillating structure is assured.

The oscillating structure of the present embodiment will be explained furthermore. The oscillating structure 106 of the present embodiment shown in FIG. 1A has two first torsion springs 104. These springs have a clearance between it and the second torsion spring 105, so that they do not contact with the second torsion spring 105 during the oscillation. If the stress to be applied to the spring is taken into account, it is desirable that the first torsion spring 104 is close to the second torsion spring 105. However, during the oscillation, they should be brought close to each other as far as they do not contact to each other. Furthermore, it is not always necessary that the first torsion spring 104 is formed in parallel to the second torsion spring 105. If it is desired to prolong the spring length from the standpoint of stress or frequency design, the first torsion spring 104 may be formed obliquely to the second torsion spring 105 or it may be formed in a meander shape.

Furthermore, a fillet may be provided at the joint between the torsion spring 104, 105 and the oscillating member 102, 103 and the supporting member 101 as required. With the provision of such fillet, the stress at such portion can be dispersed, and a larger amplitude oscillation is enabled.

Furthermore, in FIG. 1A, although the second torsion spring 105 is comprised of a single spring, it may be made of plural springs. This can be chosen based on the stress to the torsion spring, resonance mode, frequency design or the like.

Next, the oscillator device of the present embodiment will be described in more detail. The oscillator device 110 of the present embodiment shown in FIG. 1B is operated by an electromagnetic force. Furthermore, in FIG. 1B, the permanent magnet 107 is comprised of a single piece. However, the oscillator device of the present embodiment is not limited to this. A plurality of permanent magnets may be mounted on both surface of the first oscillating member 102. Alternatively, a throughbore may be formed in a portion of the first oscillating member 102, and a permanent magnet may be fitted therein. The number of used permanent magnets as well as the placement of installation may be determined by the cost, influence on dynamic characteristic and necessary magnetic force, etc. As a matter of course, an electromagnetic coil may be formed on the first oscillating member 102, and a magnet may be mounted at the position of the electromagnetic coil of FIG. 1B.

With regard to the driving means, anything other than the electromagnetic force may be used. For example, a piezoelectric member may be adhered at a suitable position (e.g., on the supporting member 109), and it may be used as a driving force source. Alternatively, an electrode of comb-tooth shape may be provided at a suitable position (e.g., the first oscillating member 102 or the first torsion spring 104), and the device is driven by an electrostatic attraction.

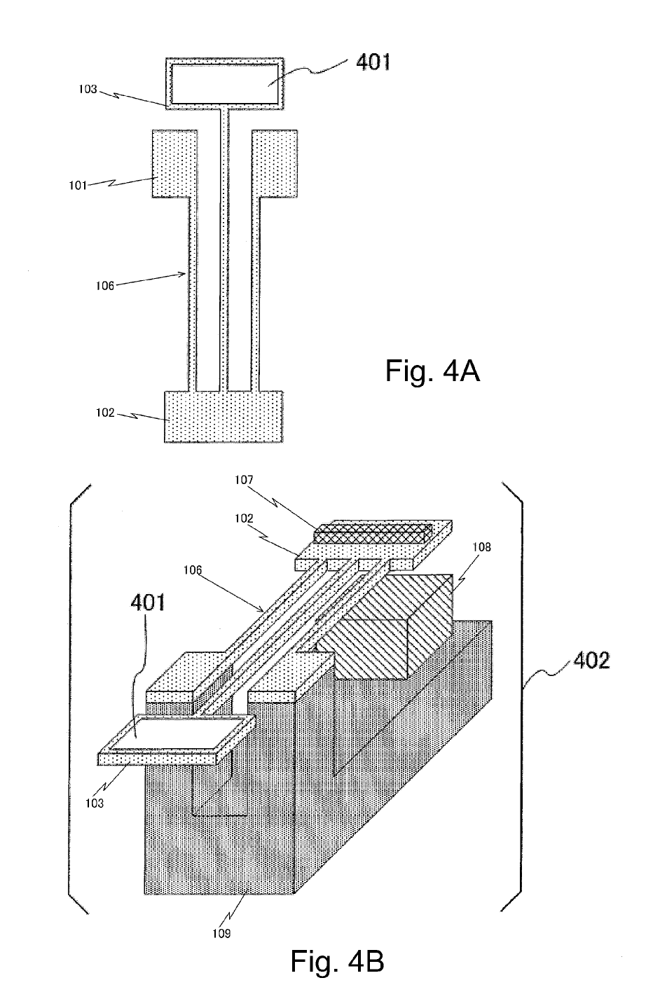

Next, referring to FIGS. 4A and 4B, an optical deflecting device according to the present embodiment will be explained. FIG. 4A shows that an optical deflection member 401 is formed on the second oscillating member 103 of the oscillating structure 106 of the present embodiment. FIG. 4B is a perspective view showing an optical deflecting device 402 of the present embodiment using an oscillating structure 106. In the optical deflecting device, a rod-like permanent magnet 107 is attached to the first oscillating member 102 of the oscillating structure 106 of FIG. 4A, and this oscillating structure 106 is attached to the supporting member 109 having an electromagnetic coil 108 mounted thereon. The optical deflection member can be selected depending on the light source used in the image forming apparatus, for example. The optical deflection member is used to deflect light from a light source. In this case, the optical deflection member is formed on at least the second oscillating member 103. However, depending on the manufacturing method of the oscillating structure 106, it may be formed to cover the first oscillating member 102, torsion springs 104 and 105 and the supporting member 101. As described above, the optical deflecting device 402 can be constituted by an oscillator device and an optical deflection member 401 disposed on at least the second oscillating member 103.

The optical deflection member may be provided on both sides of the second oscillating member 103, if necessary. In that occasion, optical deflection can be done using both sides of the second oscillating member 103. This is suitable for a color image forming apparatus using a plurality of light sources.

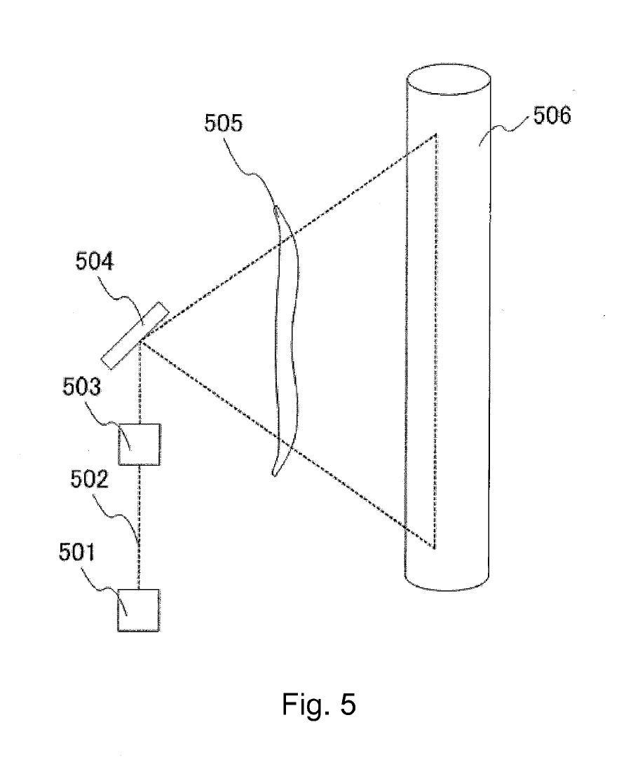

Next, referring to FIG. 5, an image forming apparatus according to the present embodiment will be explained. A laser beam 502 emitted from a light source 501 is deflected by an optical deflecting device 504, through an output optical system 503. The direction of deflection is determined by the operation of the optical deflecting device 504. The deflected light beam is collected on a photosensitive member 506 which is an object to be irradiated, through an imaging optical system 505.

The laser light 502 is projected onto the photosensitive member 506 while being appropriately turned on or off in accordance with a desired image. By this, an electric potential pattern is formed on the photosensitive member 506. Then, toner particles are adhered to the photosensitive member 506 depending on the pattern, and the attached toner is transferred to a recording medium (not shown) through a transfer belt, as required. Finally, toner fixation and the like are carried out.

The operation control of the oscillator device in the image forming apparatus of the present embodiment may be performed as follows, as an example.

In the image forming apparatus of the present embodiment, one or two beam detectors are provided in the vicinity of the opposite ends of the deflection range of the laser beam 502 and, by measuring the time when the light beam passes across the beam detector, the state of oscillation of the oscillating member is detected. The motion control is performed based on this. In this case, if one or two path bending mirrors are provided in the vicinity of the opposite ends of the deflection range, the position of the beam detector can be changed. For example, the beam detector may be provided close to the optical deflecting device 504. In that occasion, if a circuit board is required for the motion control, a common board may be used for the beam detector and the oscillator device.

As described above, an image forming apparatus can be constituted by an optical deflecting device 504, a light source 501 and and imaging optical system 508.

As other motion control methods, the motion control can be done by providing a piezoresistance sensor in a portion of the torsion spring 104 or 105. In the case of electromagnetic driving, the oscillation state of the oscillating member may be detected using an induced electromotive force which occurs in the electric coil, and the motion control can be done based on it.

In accordance with the present embodiment having been described above, since a plurality of resilient supporting members of the oscillating structure are turned around and disposed, the size of the whole system can be made small while a plurality of oscillating members are included. Furthermore, if it is necessary to thicken the material so as to deal with a problem of dynamic flexure of the components all parts to meet higher-speed driving, even if the resilient supporting member is lengthened, the size of the whole oscillating structure can be made compact.

Furthermore, in an image forming apparatus since use of an arcsine lens is no more necessary, the problem that the size of the beam spot of the laser beam upon a photosensitive member surface changes during the optical scan correction by the arcsine lens, can be avoided.

### Embodiment 2

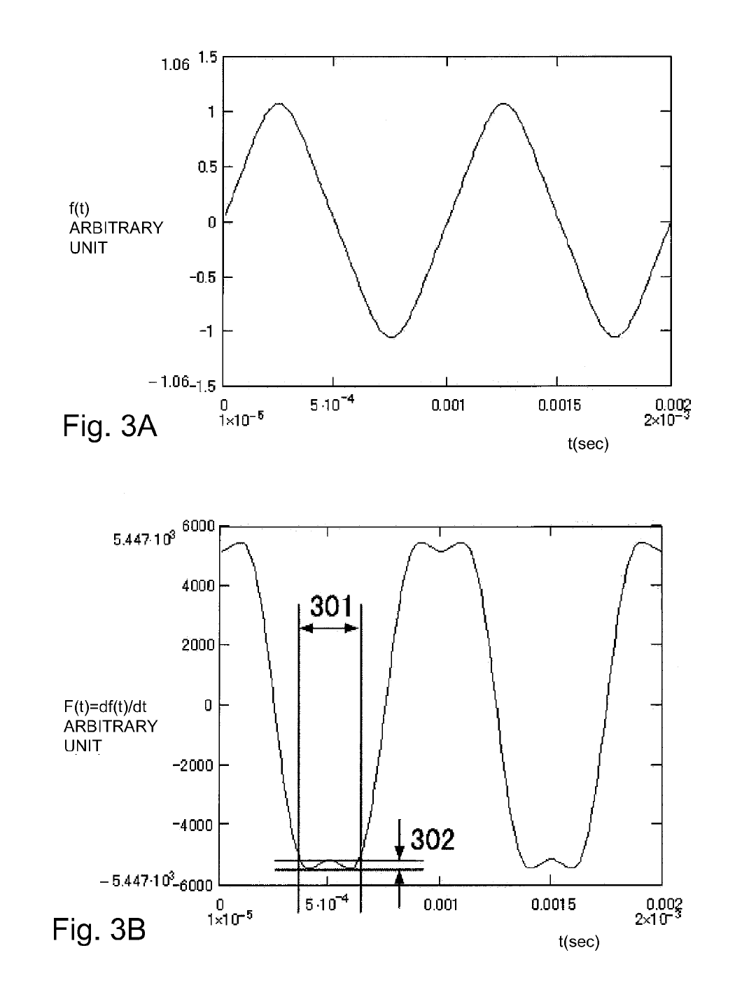

A second embodiment will be explained. The basic structure is the same as the first embodiment. Referring to FIGS. 3A and 3B, the operation of the oscillator device of the second embodiment will be explained.

In this embodiment, with the driving based on the combination of the translational mode and the regress mode, a triangle waveform such as shown in FIG. 3A is accomplished. The shape of the device or the like can be designed so that the translational mode is produced at sin(ω·t) and the regress mode is produced at sin(3·ω·t+π) and, while multiplying them by respective predetermined coefficients, these are added to each other (equation 2). Again, assuming that ω=2·π·f, it becomes possible to cause the second oscillating member 103 to produce torsional oscillation having a change with respect to time of the displacement angle of the chopping waveform as shown in FIG. 3A. Again, f=1000 [Hz] is used here.

f(t)=sin(ω·t)+0.06·sin(3·ω·t+π) (2)

If equation (2) is differentiated, the angular speed F(t) shown in FIG. 3B can be obtained. Thus, an approximately constant angular speed time 301 as well as an approximately constant angular speed range (speed variation tolerance range) 302 can be determined. Here, the approximately constant angular speed range and the approximately constant angular speed time can be changed depending on the application or the design. For example, these can be changed by changing the value of 0.06 in equation (1).

When an optical deflecting device using an oscillator device 110 of the present embodiment is incorporated into an image forming apparatus as well, depending on the design of an imaging optical system disposed between a photosensitive member and the optical deflecting device to be described below, the approximately constant angular speed range and the approximately constant angular speed time can be determined. By using the chopping waveform as mentioned above, the approximately constant angular speed range can be used promptly and repeatedly. This waveform is particularly suitable when a photosensitive member should be scanned by a laser beam, by reciprocal scan.

### Embodiment 3

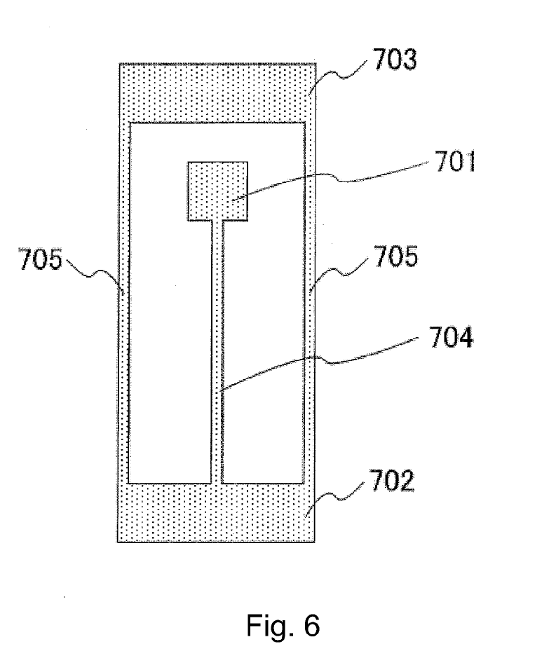

Referring to FIG. 6, an oscillating structure according to a third embodiment of the present invention will be described. FIG. 6 is a plan view which shows an oscillating structure of the present embodiment. In this embodiment, a first oscillating member 702 and a second oscillating member 703 are connected by use of two second torsion springs 705. A supporting member 701 is connected to the first oscillating member 702 by a first torsion spring 704. The supporting member 701 and the first torsion spring 704 are sandwiched by two second torsion springs 705. The shape of the present embodiment is effective when deformation of the second oscillating member 703 during operation should be reduced.

As described above, in the present embodiment the second torsion spring 705 is comprised of a plurality of springs, and the first torsion spring 704 is sandwiched by the second torsion spring 705 consisting of a plurality of springs. The operation and advantageous features of the present embodiment are similar to that of the first embodiment.

It is seen from the arrangements of the first and second embodiments that, in the oscillating structure of the present invention, at least one of the first resilient supporting member and the second resilient supporting member can be comprised of a plurality of torsion springs. Furthermore, one of the first resilient supporting member and the second resilient supporting member which comprises a plurality of torsion springs, can be configured to sandwich therein the other of the first resilient supporting member and the second resilient supporting member.

### Embodiment 4

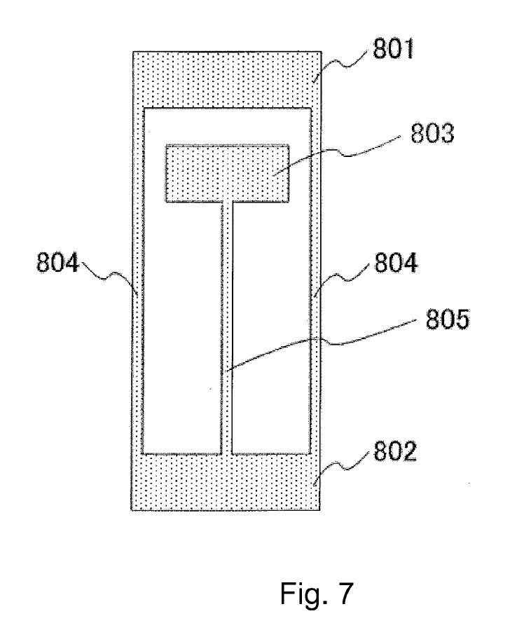

Referring to FIG. 7, an oscillating structure according to a fourth embodiment of the present invention will be described. FIG. 7 is a plan view which shows an oscillating structure of the present embodiment. In this embodiment, a second oscillating member 803 is sandwiched by two first torsion springs 804. A supporting member 801 is connected to a first oscillating member 802 by means of two first torsion springs 804, and the first oscillating member 802 is connected to a second oscillating member 803 by means of a second torsion spring 805.

In the present example, the distance between the supporting member 801 and the first oscillating member 802 can be made relatively large. As a result of this, if an electromagnetic coil is provided in the vicinities of the first oscillating member 802, for example, the position of installment thereof or the size thereof can be chosen relatively freely. The operation and advantageous features of the present embodiment as well are similar to that of the first embodiment.

### Embodiment 5

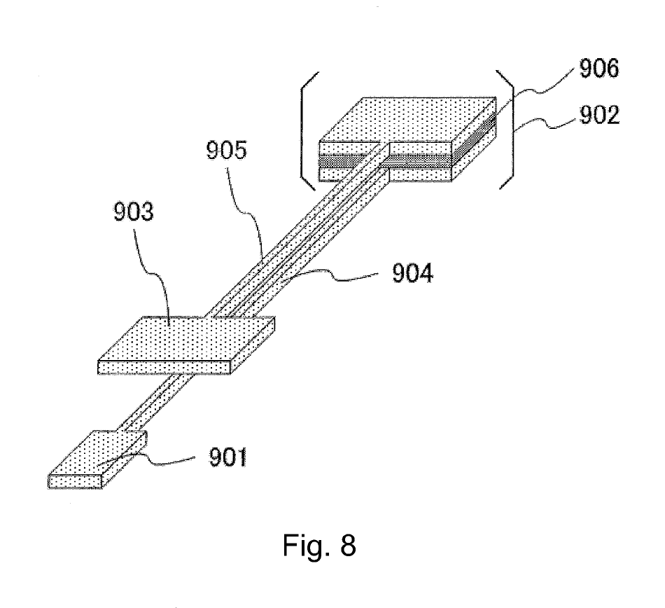

Referring to FIG. 8, an oscillating structure according to a fifth embodiment of the present invention will be described. FIG. 8 is s perspective view which shows an oscillating structure of the present embodiment. In this embodiment, a portion of a first oscillating member 902 and a first torsion spring 904 and a supporting member 901 are made from a single piece of plate-like material. Then, a second oscillating member 903 and a second torsion spring 905 and a portion of the first oscillating member 902 are made from a single piece of plate-like material. The aforementioned portions of the first oscillating member 902 are connected together. Here, with the provision of a spacer 906 between the portions of the first oscillating member 902, unwanted contact of the first torsion spring 904 and the second torsion spring 905 during the operation can be avoided.

In the case of the structure such as shown in FIG. 8, each of the first torsion spring 904 and the second torsion spring 905 can be made as a single piece of torsion spring. As a matter of course, the first torsion spring and the second torsion spring may be comprised of a plurality of torsion springs. If each torsion spring 904 or 905 is made by a single piece of spring, the oscillating members 901 and 903 can be oscillated only by the torsion (no flexure) of the torsion springs 904 and 905. Therefore, the air resistance of the spring can be almost disregarded, and there is almost no necessity of taking into account the jitter due to the air resistance of the spring, which is related to the instability of the oscillation.

When an oscillating structure is made from one piece of board material, if there is a defect in the torsion springs or the oscillating member, the oscillating structure itself becomes defective. However, if the components are assembled into an oscillating structure as in the present embodiment, since only non-defective parts can be chosen and assembled, the waste is considerably reduced.

In the present embodiment as described above, a portion of the first oscillating member and the first resilient supporting member, and the second oscillating member and the second resilient supporting member and a portion of the first oscillating member are made from separate plate-like materials, and the portions of the first oscillating member are joined together. The operation and advantageous features of the present embodiment as well are similar to that of the first embodiment.

### Embodiment 6

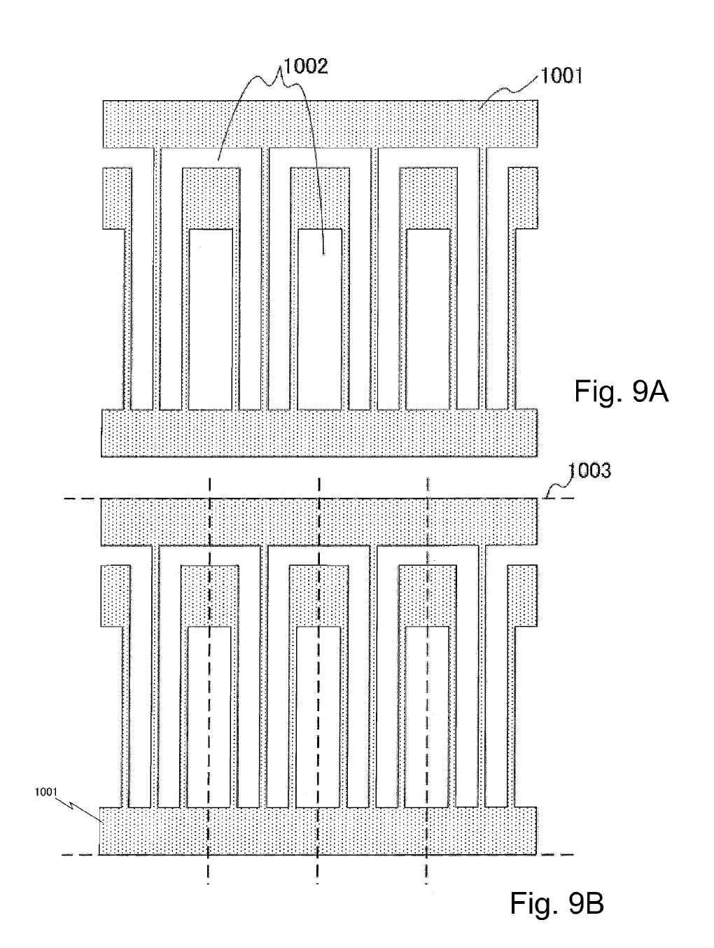

Referring to FIG. 9A through 11, an example of a method of manufacturing an oscillating structure according to the present invention will be described.

In the manufacture method shown in FIGS. 9A and 9B, first of all, a board material which is the material for the oscillating structure is prepared. With regard to the board material, a metallic material or a metal oxide may be used. When monocrystal silicon is used as a board material, an oscillating structure such as a micro-oscillating structure which has superior mechanical characteristics can be produced. Specifically, an oscillating structure having high Q-value (e.g., large oscillation with low electric voltage) and having an oscillating member which less flexed during the oscillation, can be produced.

A semiconductor process can be used for processing the monocrystal silicon. Therefore, by processing and finishing monocrystal silicon at a micrometer order, an oscillating structure having a resonance frequency as approximately exactly as designed can be accomplished.

Next, a masking layer is formed on the board material, and an appropriate opening is formed in the masking layer. The portion of the board material being exposed through the opening is removed to form a throughbore 1002 there. By doing so, an oscillating structure 1001 before separation is obtained as shown in FIG. 9A. In this case, as regards the removing method, anyone may be chosen from processing methods such as laser machining, sand blast, dry etching and wet etching.

Then, by cutting the oscillating structure 1001 before separation, along a cutting line 1003 as shown in FIG. 9B, an oscillating structure as shown in FIG. 1B is obtained.

In the manufacture method of the oscillating structure described above, since the oscillating structure is made integrally, it can be manufactured very precisely. Particularly, this embodiment is suited to a case where the oscillating structure should be made exactly to have a target resonance frequency.

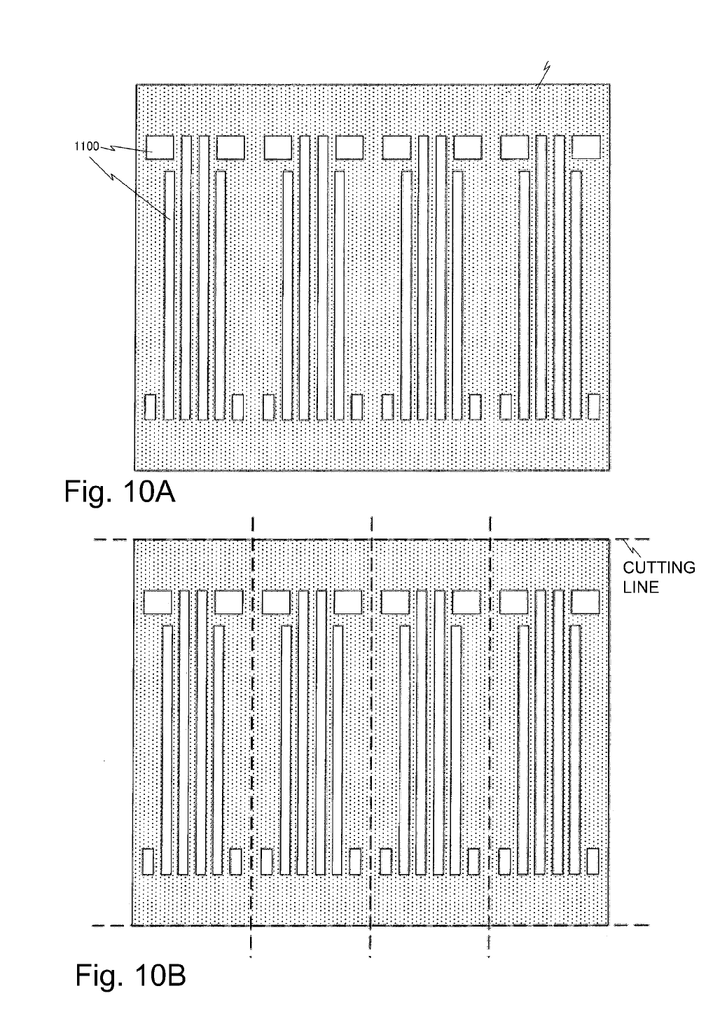

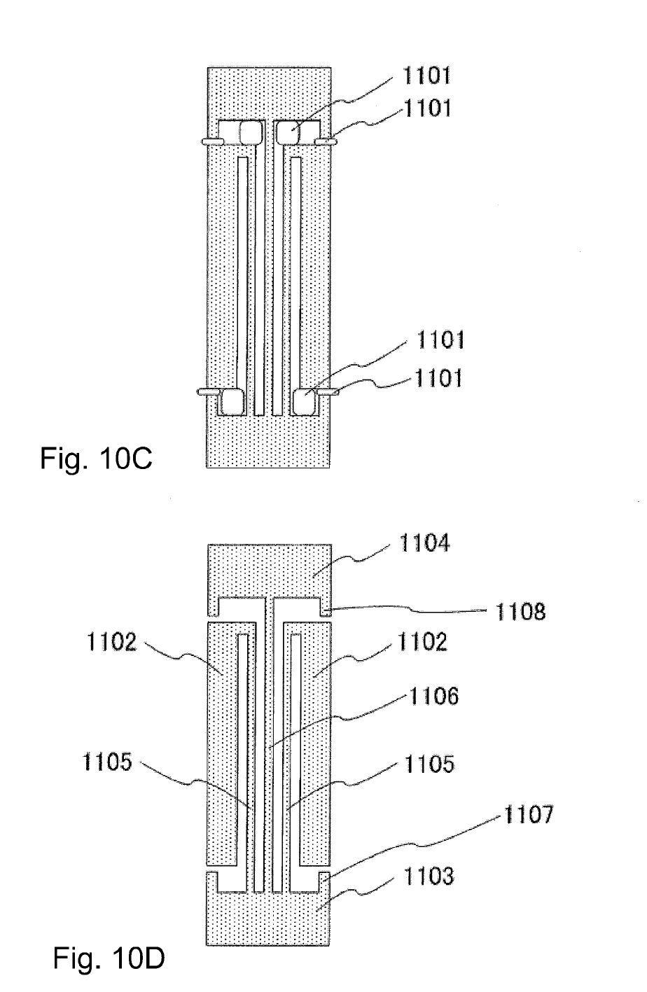

In the manufacturing method shown in FIG. 10A and FIG. 10B, all the throughbores are a quadrangular hole 1100. This is particularly effective when the throughbore is formed using crystal anisotropy etching which is a wet etching process. This is because the quadrangular hole can be easily formed by the crystal anisotropy etching.

Subsequently, the oscillating structure before separation is cut and disconnected along a cutting plane line shown in FIG. 10B, and additional machining is done at additional processing portions 1101 shown in FIG. 10C. A laser processing machine may be used, for example, for this addition machining. Then, an oscillating structure such as a micro-oscillating structure shown in FIG. 10D is obtained. This oscillating structure is provided with a weight adjusting member 1107 for the first oscillating member 1103, and a weight adjusting member 1108 for the second oscillating member 1104. If the weight of each oscillating member or bilateral balance thereof across the torsion central axis should be adjusted, the weight adjusting member may be cut furthermore or, alternatively, a groove or hole may be formed. An additional weight adjusting member may be attached. The weight adjusting member may be provided at only one oscillating member. This oscillating structure as well comprises a pair of supporting members 1102, a first oscillating member 1103, a second oscillating member 1104, a first torsion spring 1105 which is comprised of a pair of springs (first resilient supporting members), and a second torsion spring 1106 which is the second resilient supporting member.

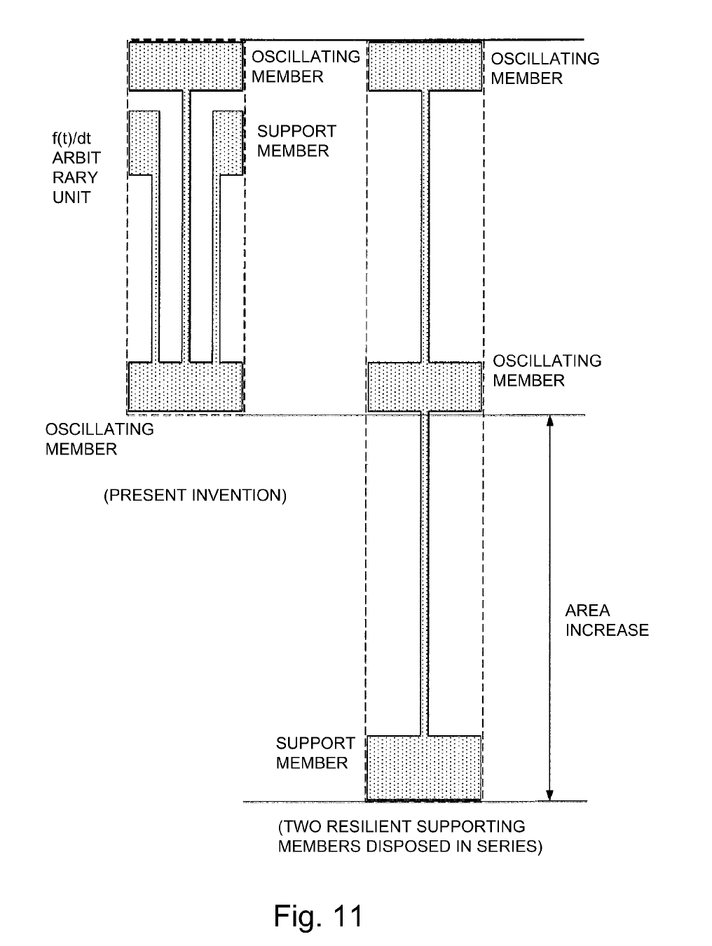

In accordance with the manufacturing method shown in FIGS. 9A through FIG. 10D, while making use of the feature of a compactness of the oscillating structure of the present invention, the number of product oscillating structures obtainable per one piece of wafer can be increased. FIG. 11 visually illustrates the increase of the number of product oscillating structures obtainable per a single wafer, in comparison with the case of an oscillating structure having a plurality of resilient supporting members disposed in series. In the case of serial disposition, it is clear that there is one more oscillating structure at the zone where the area has increased and, thus, the number of the oscillating structures obtainable per a single wafer is necessarily decreased (in the illustrated example, the number becomes about a half). Furthermore, a large amount of material has to be removed, resulting in a large waste.

### Other Embodiment

In the embodiments described hereinbefore, the number of the oscillating members and the number of the resilient supporting members are two. However, the number may be three or more. In that occasion, the number of natural oscillation modes can be increased as well, and a wider variety of mode combinations can be accomplished for the driving. Thus, the design of the oscillatory motion of the oscillating member can be made in various ways. Furthermore, because of the increase of the number of oscillating members and the number of the resilient supporting member, the approximately constant speed region can be widened. As a result of this, the region out of the scan region which can be used for the approximately constant speed can be widened. Furthermore, the constant speed characteristics of the approximately constant speed can be improved as well. For example, the lens correction is facilitated furthermore.

In order to provide a structure having three or more oscillating members and resilient supporting members, in the example of FIG. 1, for example, the second resilient supporting member 105 may be comprised of two springs and, between these two second resilient supporting members, a third resilient supporting member may be extended from the second oscillating member 103 while being turned around therefrom, and a third oscillating member may be provided at the tip end thereof.

In the example of FIG. 6, for example, outside two springs of a second resilient supporting member 705, a third resilient supporting member comprised of two springs may be extended while being turned around from the second oscillating member 703, and a third oscillating member may be provided at the tip end thereof.

In the example of FIG. 7, for example, the second resilient supporting member 805 may be comprised of two springs and, between these two second resilient supporting members, a third resilient supporting member may be extended while being turned around from the second oscillating member 803, and a third oscillating member may be provided at a tip end thereof.

In the example of FIG. 8, for example, the second oscillating member 903 may have a structure such as the first oscillating member 902, and a third resilient supporting member may be extended while being turned around from the second oscillating member 903, and a third oscillating member may be provided at the tip end thereof.

Furthermore, the structures described above may be combined in an appropriate way. For example, if the number of the oscillating member is three or more, the structure of FIG. 8 can be easily combined with other embodiments.

Furthermore, in the case of an oscillating structure including three or more oscillating members and three or more resilient supporting members, in addition to the folding structure of a plurality of resilient supporting members described with reference to the foregoing embodiment, a structure having a plurality of resilient supporting members disposed in series may be included.

While the invention has been described with reference to the structures disclosed herein, it is not confined to the details set forth and this application is intended to cover such modifications or changes as may come within the purposes of the improvements or the scope of the following claims.

1. An oscillating structure, comprising:
a supporting member;
a first oscillating member;
a second oscillating member;
a first resilient supporting member configured to connect the supporting member and the first oscillating member and to support the first oscillating member for oscillatory motion around the supporting member as a central axis; and
a second resilient supporting member configured to connect the first oscillating member and the second oscillating member and to support the second oscillating member movably relative to the first oscillating member;
wherein the direction in which the first resilient supporting member extends from the supporting member to the first oscillating member and the direction in which the second resilient supporting member extends from the first oscillating member to the second oscillating member are opposite to each other.

2. An oscillating structure according to claim 1, wherein the first and second oscillating members and the first and second resilient supporting member are made of a single piece of plate-like member.

3. An oscillating structure according to claim 1, wherein a portion of the first oscillating member and the first resilient supporting member, and the second oscillating member, the second resilient supporting member and a portion of the first oscillating member are made from separate plate-like members, and wherein the portions of the first oscillating member are joined together.

4. An oscillating structure according to any one of claims 1-3, wherein at least one of the first resilient supporting member and the second resilient supporting member comprises a plurality of torsion springs.

5. An oscillating structure according to claim 4, wherein one of the first resilient supporting member and the second resilient supporting member which comprises a plurality of torsion springs is configured to sandwich therein the other of the first resilient supporting member and the second resilient supporting member.

6. An oscillating structure according to any one of claims 1-3, wherein the first resilient supporting member and the second resilient supporting member have a common torsion central axis.

7. An oscillating structure, comprising:
a supporting member;
a plurality of oscillating members; and
a plurality of resilient supporting members;
wherein, in an order from the supporting member, the resilient supporting members and the oscillating members are alternately connected, and
wherein the direction in which an “n”th resilient supporting member connected to an “n”th oscillating member extends, where n is an integer not less than 1 as counted from the supporting member side, and the direction in which an “n+1”th resilient supporting member connected to an “n+1”th oscillating member extends are opposite to each other.

8. An oscillator device, comprising:
an oscillating structure as recited in any one of claims 1 and 7; and
driving means configured to apply a torque to at least one of the first and second oscillating members of the oscillating structure.

9. An optical deflecting device, comprising:
an oscillator device as recited in claim 8; and
an optical deflection member disposed at least at the second oscillating member of the oscillator device.

10. An image forming apparatus, comprising:
an optical deflecting device as recited in claim 9;
a light source;
an imaging optical system; and
an object to be irradiated,
wherein a light beam from the light source is scanned by the optical deflecting device and the scanned light is collected onto the object.
